(19) United States
(12) Patent Application Publication
(10) Pub. No.: US 2009/0268821 A1
(43) Pub. Date: Oct. 29, 2009

(54) BLOCK PARALLEL AND FAST MOTION ESTIMATION IN VIDEO CODING

(75) Inventors: Oscar Chi Lim Au, Hong Kong (CN); Man Cheung Kung, Hong Kong (CN)

Correspondence Address: TUROCY & WATSON, LLP, 127 Public Square, 57th Floor, Key Tower, CLEVELAND, OH, 44114, US

(73) Assignee: THE HONG KONG UNIVERSITY OF SCIENCE AND TECHNOLOGY, Hong Kong (CN)

(21) Appl. No.: 12/111,322

(22) Filed: Apr. 29, 2008

(51) Int. Cl. H04N 11/02

(52) U.S. Cl. 375/240.16; 375/E07.076

(57) ABSTRACT

Block parallel fast motion estimation for blocks of a video frame is provided where encoding of video blocks can be ordered to allow concurrent encoding thereof. Furthermore, motion vector prediction can be performed concurrently for independent video blocks where requisite blocks for calculating the prediction of a given block can be previously encoded, but not all blocks depend from each other; thus, parallel motion vector estimation is possible. Additionally, a fast motion estimation algorithm can be concurrently performed on a number of video blocks to search surrounding blocks to compute motion vectors as well. The concurrent processes can leverage the parallel architecture of one or more graphical processing units (GPU).

### TECHNICAL FIELD

The following description relates generally to digital video coding, and more particularly to techniques for motion estimation.

### BACKGROUND

The evolution of computers and networking technologies from high-cost, low performance data processing systems to low cost, high-performance communication, problem solving, and entertainment systems has increased the need and desire for digitally storing and transmitting audio and video signals on computers or other electronic devices. For example, everyday computer users can play/record audio and video on personal computers. To facilitate this technology, audio/video signals can be encoded into one or more digital formats. Personal computers can be used to digitally encode signals from audio/video capture devices, such as video cameras, digital cameras, audio recorders, and the like. Additionally or alternatively, the devices themselves can encode the signals for storage on a digital medium. Digitally stored and encoded signals can be decoded for playback on the computer or other electronic device. Encoders/decoders can use a variety of formats to achieve digital archival, editing, and playback, including the Moving Picture Experts Group (MPEG) formats (MPEG-1, MPEG-2, MPEG-4, etc.), and the like.

Additionally, using these formats, the digital signals can be transmitted between devices over a computer network. For example, utilizing a computer and high-speed network, such as digital subscriber line (DSL), cable, T1/T3, etc., computer users can access and/or stream digital video content on systems across the world. Since the available bandwidth for such streaming is typically not as large as locally accessing the media within a computer, and because processing power is ever-increasing at low costs, encoders/decoders often aim to require more processing during the encoding/decoding steps to decrease the amount of bandwidth required to transmit the signals.

Accordingly, encoding/decoding methods have been developed, such as motion estimation, to provide block (e.g., pixel or region) prediction based on a previous reference frame, thus reducing the amount of block information that should be transmitted across the bandwidth as only the prediction need be encoded and not necessarily the entire block. For example, motion vector prediction and early termination are used in some implementations to achieve fast motion estimation. These methods, however, can introduce peak signal to noise ratio loss. Moreover, the methods for motion estimation and video coding are usually computationally expensive, and introduce recurrent dependency among adjacent blocks during encoding.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

Efficient inter-frame motion estimation is provided that mitigates adjacent block (e.g., pixel or regions of pixels) dependency in video frames by rearranging block encoding order and utilizes a fast motion estimation algorithm for determining motion vectors. Additionally, at least a portion of the motion estimation can be performed on a graphics processing unit (GPU) to achieve high-degree parallelism. Thus, selecting a block encoding order that removes adjacent block dependency can allow the parallel architecture of the GPU to synchronously encode a number of blocks in the video frame increasing encoding efficiency. Moreover, a fast motion estimation algorithm can be performed for encoding the blocks by leveraging the GPU.

For example, an encoding determination for a block in motion estimation can require motion vector information with respect to adjacent blocks of a video frame, such as calculating a motion vector predictor as a median of a number of adjacent block motion vectors. Therefore, ordering encoding of the blocks such that blocks independent of each other can be concurrently encoded following encoding of required adjacent blocks allows for advantageous utilization of parallel processing, which can be performed via a GPU parallel architecture, for example. Additionally, in one example, a multiple step search algorithm can be performed to locate an optimal motion vector for the motion estimation using the GPU to concurrently search for potentially matched blocks, or pixels thereof, between a current block and a reference block.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 illustrates a block diagram of an exemplary system that estimates motion in parallel for encoding video.

FIG. 2 illustrates a block diagram of an exemplary system that orders video blocks for concurrent encoding.

FIG. 3 illustrates an example portion of a video frame ordered for concurrent decoding of a portion of the video blocks.

FIG. 4 illustrates a block diagram of an exemplary system that utilizes inference to estimate motion and/or encode video.

FIG. 5 illustrates an exemplary flow chart for ordering video blocks for concurrent encoding thereof.

FIG. 6 illustrates an exemplary flow chart for concurrently predicting motion vectors for disparate video blocks.

FIG. 7 illustrates an exemplary flow chart for concurrently performing fast motion estimation over disparate video blocks.

FIG. 8 is a schematic block diagram illustrating a suitable operating environment.

FIG. 9 is a schematic block diagram of a sample-computing environment.

### DETAILED DESCRIPTION

Parallel block video encoding using fast motion estimation is provided where independent blocks of pixels or regions can be concurrently encoded based at least in part on adjacent previously encoded blocks using motion estimation and/or motion vector prediction. In one example, parallel processing functionality of a graphics processing unit (GPU) can be leveraged to effectuate the concurrent encoding. Moreover, fast motion estimation algorithms, such as a multiple-step search algorithm, can be utilized for efficient motion vector determination of given blocks. In addition, the multiple-step search algorithm can be performed using the GPU for parallel processing thereof, in one example.

For example, the blocks of a video frame, which can be one or more pixels or regions of pixels of varying size, can be ordered for encoding such that the order ensures requisite adjacent blocks for calculating a motion vector predictor (the median or mean average motion vector based on a number of adjacent blocks) have been encoded. Moreover, the blocks ordered with the same number are independent of each other for encoding purposes allowing the similarly ordered blocks to be encoded concurrently. Furthermore, the motion estimation encoding process can utilize a three step search (TSS) type of algorithm to determine the motion vector based on comparison with a number of reference blocks. It is to be appreciated that a modified TSS algorithm can be used in addition or alternative, such as a five-step search (FSS), six-step search (SSS), etc. A cost can be computed as to decoding the motion vector or a residue between the motion vector and the predictor, and the video block can be accordingly encoded.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

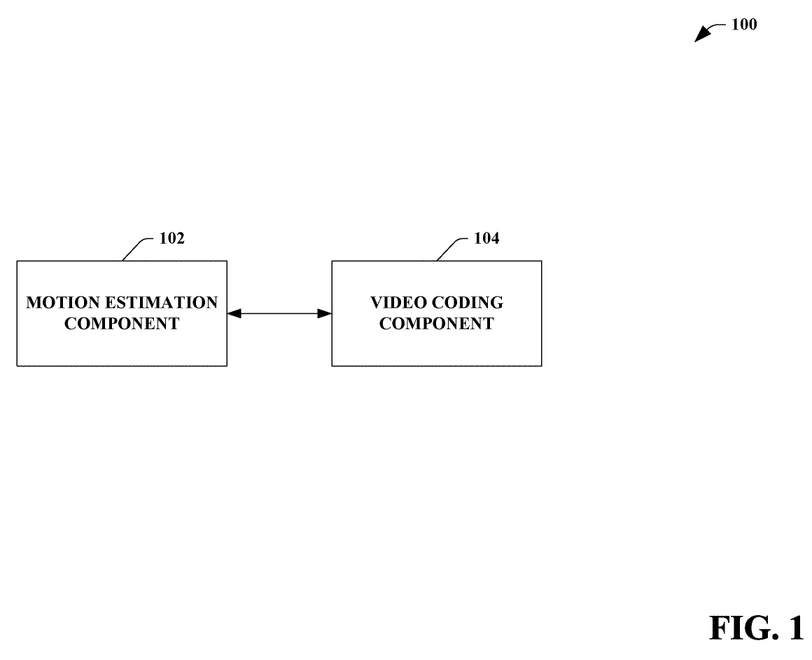

Now turning to the figures, FIG. 1 illustrates a system 100 that facilitates estimating motion for digitally encoding video. A motion estimation component 102 is provided that can utilize one or more reference blocks to predict a video block based at least in part on a motion vector and a video coding component 104 that encodes video to a digital format based at least in part on the predicted video block. It is to be appreciated that a block can be, for example, a pixel, a collection of pixels, a region of pixels (of fixed or variable size), or substantially any portion of a video frame. For example, upon receiving a frame or block for encoding, the motion estimation component 102 can evaluate one or more reference video blocks or frames to predict the current video block or frame such that only a motion vector and/or information related thereto need be encoded. The video coding component 104 can encode a motion vector for the video block, which can be predicted or computed based at least in part on motion vectors for surrounding video blocks, for subsequent decoding in one example. In another example, the video coding component 104 can encode a residue between the motion vector and a predicted motion vector, which can be an average (e.g., median, mean, etc.) of one or more motion vectors for adjacent blocks. In either case, the vector or residue information related to a block is substantially smaller than information for each pixel of the block; thus, bandwidth can be saved at the expense of processing power by encoding the vector or residue. This can be at least partially accomplished by using the H.264/advanced video coding (AVC) standard or other motion picture experts group (MPEG) standard, for instance.

In one example, a video frame can be separated into a number of video blocks by the video coding component 104 (or motion estimation component 102), as mentioned, for encoding the frame using motion estimation. Moreover, the blocks can be ordered by the video coding component 104 for encoding such that the encoding can be concurrently performed for given independent blocks. In this regard, a parallel processor can be utilized by the motion estimation component 102 to search video blocks for determining motion vectors based on a reference block in parallel increasing efficiency in the prediction and therefore the encoding. For example, a graphics processing unit (GPU) can have a parallel architecture, and thus, can be utilized for general purpose computing (GPGPU) in this way. It is to be appreciated that substantially any motion estimation algorithm can be utilized by the motion estimation component 102 to determine motion vectors, including but not limited to step searches, as shown by way of example below, full searches, and/or the like.

Moreover, motion vectors of surrounding blocks can be utilized to create a motion vector predictor and estimate cost of encoding residue between the predictor and the motion vector for the current block. Thus, the video coding component 104 can take this into account when ordering the blocks to ensure the requisite blocks for computing the motion vector predictor are encoded before the appropriate block. Additionally, the video coding component 104 can encode the video block according to the motion vector based on the reference block in parallel by utilizing the GPU. Parallelizing these steps of motion estimation can significantly decrease processing time for encoding video according to a motion estimation algorithm. It is to be appreciated that the motion estimation component 102 and/or video coding component 104 can leverage, or be implemented within, a GPU or other processor, in separate processors, and/or the like, in one example.

In addition, the motion estimation component 102, video coding component 104, the functionalities thereof, and/or processors implementing the functionalities, can be integrated in devices utilized in video editing and/or playback. Such devices can be utilized, in an example, in signal broadcasting technologies, storage technologies, conversational services (such as networking technologies, etc.), media streaming and/or messaging services, and the like, to provide efficient encoding/decoding of video to minimize bandwidth required for transmission. Thus, more emphasis can be placed on local processing power (e.g., one or more central processing units (CPU) or GPUs) to accommodate lower bandwidth capabilities, in one example, and appropriate processors can be utilized, such as GPGPU, to efficiently encode video.

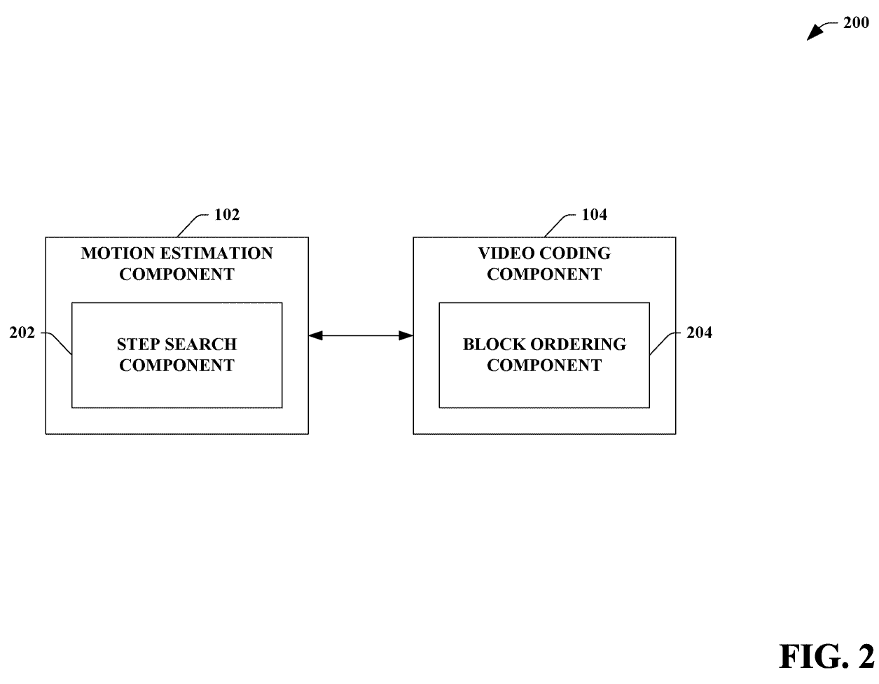

Referring to FIG. 2, a system 200 for providing efficient inter-frame video coding by mitigating block dependency is shown. A motion estimation component 102 is provided to determine and/or predict motion vectors and/or related residue for video blocks; a video coding component 104 is also provided to encode the frames or blocks of the video (e.g., as vector or residue information) for transmission and/or subsequent decoding. The motion estimation component 102 can include a step search component 202 that can perform a multiple-step search for a given video block to determine a motion vector from a previous reference block. Additionally, the video coding component 104 can include a block ordering component 204 that can specify an order to be utilized in encoding the blocks of a given video frame. As mentioned, the order specified by the block ordering component 204 can allow parallel encoding of independent video blocks.

For example, the step search component 202 can be utilized to determine motion vectors for video blocks based on one or more reference blocks. The step search component 202 can perform a multiple-step search for a given video block to be encoded by evaluating the block with respect to a set of reference blocks of a previous video reference frame. For example, the block to be encoded can be compared to a similarly positioned block of the reference image as well as additional surrounding blocks. In typical step searches, for example, blocks at eight substantially equidistant positions from the similarly positioned block in the reference frame can be evaluated as well; typically, the positions are at the four corners and midpoints at the four edges of the search window. One or more of the nine total blocks with a computed minimum cost for coding the motion vector can become a next focal point where eight surrounding, but nearer in proximity, video blocks can be evaluated moving-in on the block with a lowest cost until the video block is evaluated with respect to immediately surrounding blocks. Thus, the range chosen for the step search algorithm can affect the number of steps necessary to arrive at a minimum cost video block utilized to determine the appropriate motion vector. For example, FSS can allow up to a 16 block search window from each direction from the video block, and SSS can allow up to a 32 block search; thus, for a given number of steps n, a 2ⁿ pixel search window can be utilized. It is to be appreciated that the search can be performed over variable lengths or sizes of blocks, or pixels thereof, for example. Furthermore, a similar step search of substantially any degree can be utilized in this regard, or a completely different fast motion estimation algorithm, such as a full search for example, can be used by the step search component 202. This is just one of many possible example searches to be utilized.

In addition, the block ordering component 204 can order the video blocks of a frame being encoded such that a number of blocks can be encoded in parallel, for instance where the blocks do not depend from the other blocks that are encoded at the same time. For example, the video coding component 104 can evaluate motion vectors of surrounding blocks to calculate a motion vector predictor for the current block being encoded and can estimate a cost of coding a motion vector residue between the determined motion vector and the motion vector predictor. Thus, the blocks can be ordered by the block ordering component 204 such that requisite blocks for calculating the motion vector predictor for a given block are encoded by the video coding component 104 first. Additionally, blocks that are independent of one another can be encoded by the video coding component 104 at the same time.

In one example, the cost of coding the residue can be calculated using the following Lagrangian cost function,

J(m,λ)=D(C,P(m))+λ(R(m−p)),

where C is the original video signal, P is the reference video signal, m is the current motion vector, p is the motion vector predictor for the current block (e.g., a median of surrounding motion vectors), and λ is the Lagrange multiplier, which can be quantization parameter (QP) independent. Moreover, R(x) represents bits used to encode motion information; D(x) can be a sum of absolute differences (SAD) between the original video signal and the reference video signal or SAD of Hadamard-transformed coefficients (SATD). A motion vector can be selected by the video coding component 104 such to minimize the cost computed by the foregoing function. It is to be appreciated that other cost functions can be used as well. Additionally, the cost of coding the motion vector can be compared with a cost of encoding a residue motion vector related to the difference in a predicted motion vector and the actual motion vector, in one example; the resulting encoding can depend on the calculated cost. Further, it is to be appreciated that the fast motion estimation algorithm chosen by the step search component 202 can be different for given video blocks in one example. Moreover, as described, the functionalities provided by the step search component 202 and/or the block ordering component 204, as well as predicting motion vectors, can leverage, or be implemented within, a GPU having parallel architecture to provide further efficiency.

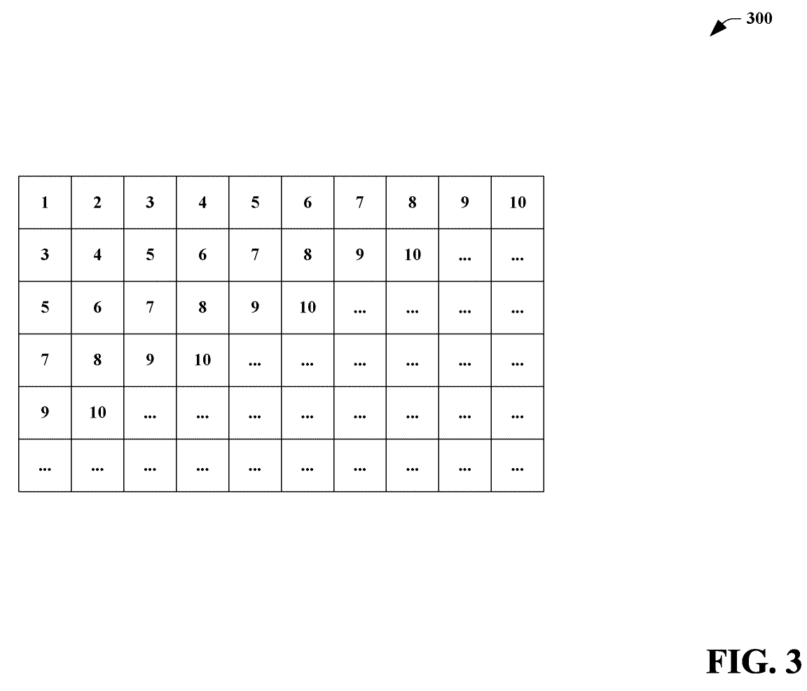

Turning now to FIG. 3, an example portion of a video frame 300 is displayed divided into ordered blocks to facilitate parallel encoding of the blocks. The blocks shown can be of varying pixel sizes, and indeed a given block can be of a different pixel size than a disparate block in one example. The blocks can be square (e.g., n×n pixels) or rectangular (e.g., n×m pixels where n and m are disparate integers). Moreover, the blocks can have a varying number of pixels in a given row or column as compared to other rows or columns in one example. In the illustrated example, for a given video block, the immediately surrounding blocks (e.g., an eight block square surrounding the video block) lower in number can be utilized in motion vector prediction as explained previously. Thus, for a block numbered 7, one or more of the surrounding blocks numbered 4, 5, or 6 can be utilized to predict the motion vector. Additionally, as no block numbered 7 is adjacent to another block numbered 7, substantially all blocks numbered 7 can be encoded in parallel as there is no dependency between the blocks.

In one example, some coding standards, such as H.264/AVC utilize the block immediately left of the current block as well as the block immediately above the current block and the block to the upper right of the current block to predict the motion vector for the current block. Thus, for the blocks numbered 7, the block labeled 5 as well as the two blocks labeled 6 can be utilized to predict a motion vector for block 7. Because the blocks are lower in number, they are already encoded as motion vectors and can be averaged to produce the predicted motion vector for a given block 7. The blocks of the example video frame portion 300 can be encoded from top left to bottom right in this regard, and a parallel processor, such as a GPU or other processor, can be utilized to concurrently encode like-numbered blocks rendering the encoding more efficient than where all blocks depend from one another.

It is to be appreciated that the blocks can be ordered in substantially any way according to the algorithm being utilized. For example, the aforementioned ordering can be reversed starting at the bottom right and working to the top left, etc. Moreover, it is to be appreciated that portions of a video frame can be encoded in parallel by one or more GPUs or other processors as well. Thus, the video frame portion 300 can be one of many portions, or macro blocks, of a larger video frame, which can be encoded using the mechanisms explained above in parallel with other portions, for example. Furthermore, as described, the encoding for each video block can be performed using substantially any fast motion estimation algorithm, such as a multiple-step search (e.g., TSS, FSS, SSS, or substantially any number of steps), a full search, and/or the like to estimate a best motion vector for the given video block. Subsequently, the cost of encoding the motion vector or a residue between the motion vector and the predicted motion vector can be weighed in deciding which to encode, in one example.

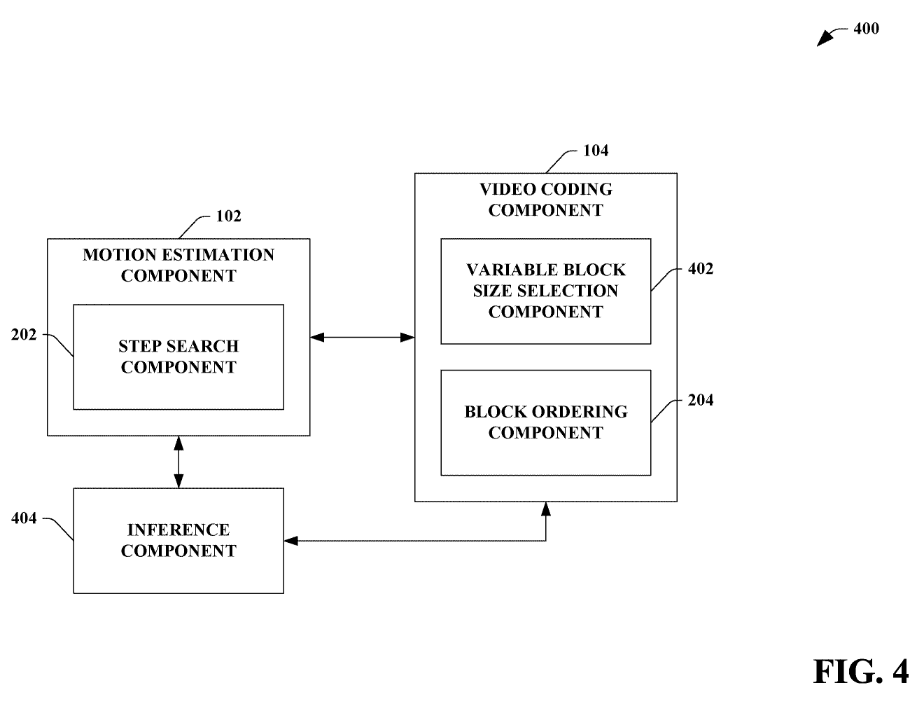

Referring now to FIG. 4, a system 400 that facilitates encoding video blocks in parallel as one or more motion vectors determined from one or more reference blocks is shown. A motion estimation component 102 is provided that can determine a video block based at least in part on a motion vector for encoding via a provided video coding component 104. The motion estimation component 102 can include a step search component 202 that can determine a motion vector for a video block, or portion thereof, based at least in part on a portion of a reference frame as described. The video coding component 104 can include a block ordering component 204 that can order video block encoding to allow independent blocks to be encoded in parallel as well as a variable block size selection component 402 that can specify one or more block sizes for video blocks of a video frame to be encoded. Furthermore, an inference component 404 is included that can infer one or more aspects related to encoding the video blocks.

In one example, the video coding component 104 can utilize the variable block size selection component 402 to separate a given video frame into one or more video blocks. As described above, the blocks can be square or can have a different number of pixels in given rows or columns of the block; additionally, the blocks can be single pixels or portions thereof, for example. Moreover, the blocks can be of varying size throughout the video frame. In one example, the video blocks are 4 pixels by 4 pixels. Additionally, the blocks can be grouped into sets of macro blocks, in one example. The inference component 404 can be utilized by the variable block size selection component 402 to determine an optimal size for one or more blocks or macro blocks of the video frame. The inference can be made based at least in part on previous encodings (within the same or different video), CPU/GPU ability, bandwidth requirements, video size, etc.

In addition, the video blocks can be ordered by the block ordering component 204. As described, the ordering can relate to preserving ability to encode one or more video blocks in parallel. Again, the inference component 404 can infer such an order based at least in part on a desired encoding scheme or direction (e.g., top left to bottom right, etc.), type of processor being utilized, resources available to the processor, bandwidth requirements, video size, previous orderings, and/or the like. Furthermore, the step search component 202 can leverage the inference component 404 to select a fast motion estimation algorithm to utilize for determining one or more motion vectors related to a give video block. For example, the inference can be made as described above, depending on a previous algorithm, processing ability or requirements, time requirements, size requirements, bandwidth available, etc. Additionally, the inference component 404 can make inferences based on factors such as encoding format/application, suspected decoding device or capabilities thereof, storage format and location, available resources, etc. for the above-mentioned components. The inference component 404 can also be utilized in determining location or other metrics regarding a motion vector, and the like.

The aforementioned systems, architectures and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent, for instance by inferring actions based on contextual information. By way of example and not limitation, such mechanism can be employed with respect to generation of materialized views and the like.

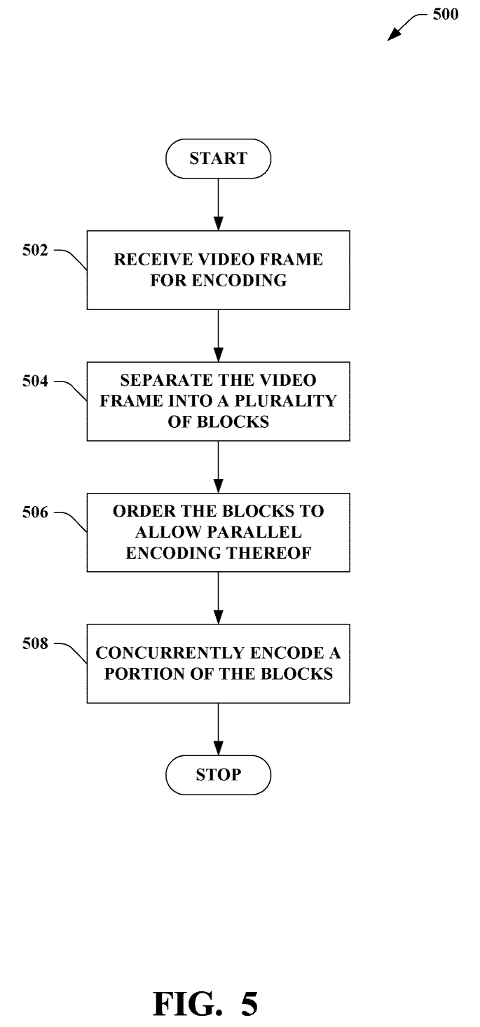

In view of the exemplary systems described supra, methodologies that may be implemented in accordance with the disclosed subject matter will be better appreciated with reference to the flow charts of FIGS. 5-7. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 5 shows a methodology 500 for concurrent motion estimation of video blocks related to a reference frame to encode the video blocks. At 502, a video frame is received for encoding. For example, the frame can be encoded as one or more motion vectors related to a reference frame as described. The video frame can be one of a plurality of frames of a video signal, for instance. At 504, the video frame can be separated into a plurality of video blocks to allow diverse encoding thereof. As described previously, the blocks can be of substantially any size, and in fact can vary among the blocks in one example. In one example, the blocks can be n pixels by m pixels where n and m can be the same or different integers.

At 506, the blocks can be ordered to allow parallel encoding thereof. As described, depending on a motion estimation algorithm, blocks utilized for estimating or predicting motion vectors for a current block can be encoded before the current block. However, the blocks can be ordered such that blocks independent of each other for encoding purposes can be encoded in parallel as shown supra. It is to be appreciated that the blocks can be ordered in substantially any manner to achieve this end; the examples shown above are for the purpose of illustrating of possible schemes. At 508, a portion of the blocks can be concurrently encoded according to the imposed order. This can be performed via a GPU in one example.

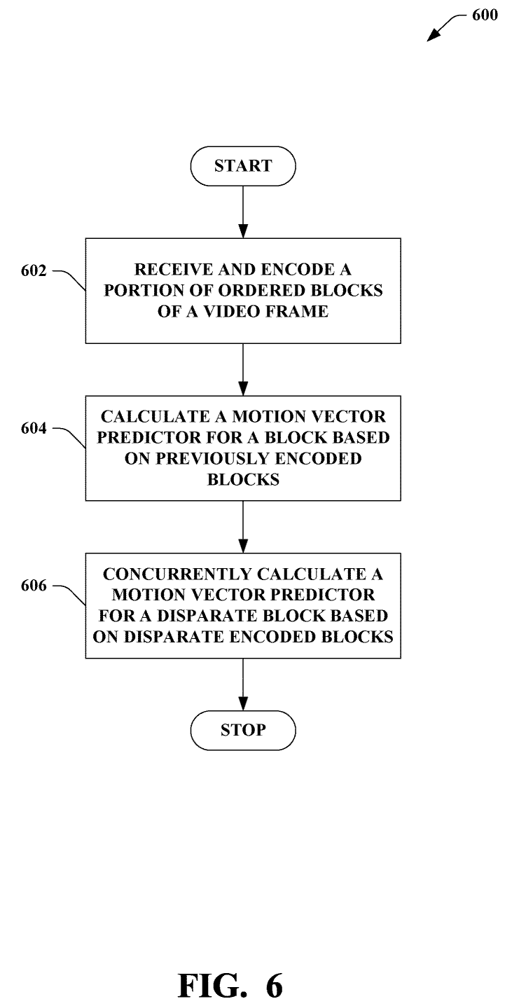

FIG. 6 illustrates a methodology 600 that facilitates concurrently calculating motion vector predictors for a number of video blocks of a given frame. At 602, a portion of ordered blocks of a video frame are received; the blocks can be ordered as described previously, for example, to allow parallel encoding thereof. At 604, a motion vector predictor can be calculated for a block based on previously encoded blocks. In one example, the motion vector can be predicted based at least in part on evaluating one or more adjacent video blocks. In H.264/AVC, the blocks immediately left, to the top, and the top right of the current block are used for predicting motion vectors. For instance, as described, the blocks can be ordered such that blocks needed to calculate the motion vector predictor can be encoded before the current block. Additionally, blocks not needed for such calculations can be similarly ordered such that they can be encoded in parallel. At 606, a motion vector predictor for such a block is concurrently calculated using disparate encoded blocks. Thus, removing dependency between blocks allows for concurrent encoding or motion vector prediction thereof.

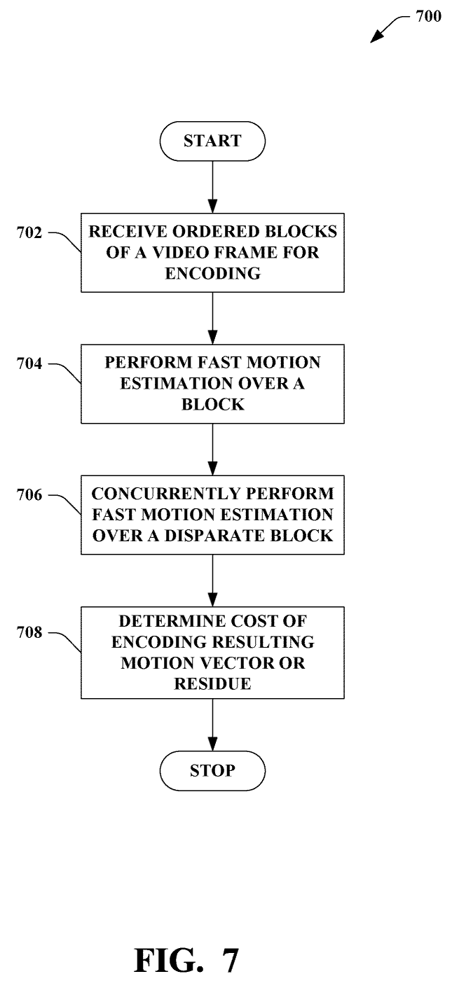

FIG. 7 shows a methodology 700 for concurrently performing fast motion estimation on a plurality of video blocks of a video frame. At 702, ordered blocks of a video frame are received for encoding; the blocks can ordered as described above to allow concurrent encoding or motion vector prediction thereof. At 704, fast motion estimation can be performed over a block. This can be substantially any motion estimation algorithm such as a step search (e.g., TSS, FSS, SSS, and/or substantially any number as described), a full search, and/or the like. At 706, fast motion estimation can be performed concurrently over a disparate block. It is to be appreciated that a disparate motion estimation algorithm can be utilized for the disparate block, in one example. At 708, a cost of encoding the resulting motion vector or a residue related to the predicted motion vector can be determined. Depending on the cost(s), the video block can be accordingly encoded.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit the subject innovation or relevant portion thereof in any manner. It is to be appreciated that a myriad of additional or alternate examples could have been presented, but have been omitted for purposes of brevity.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally, it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

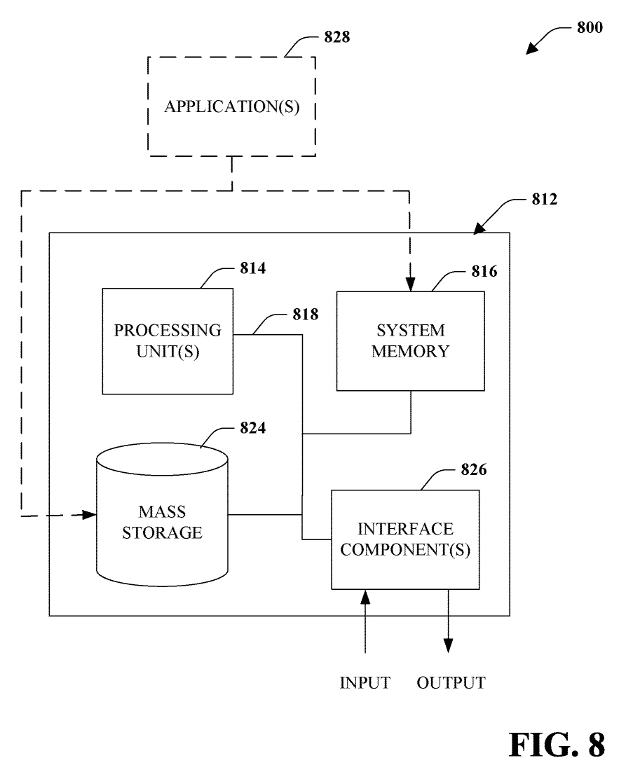

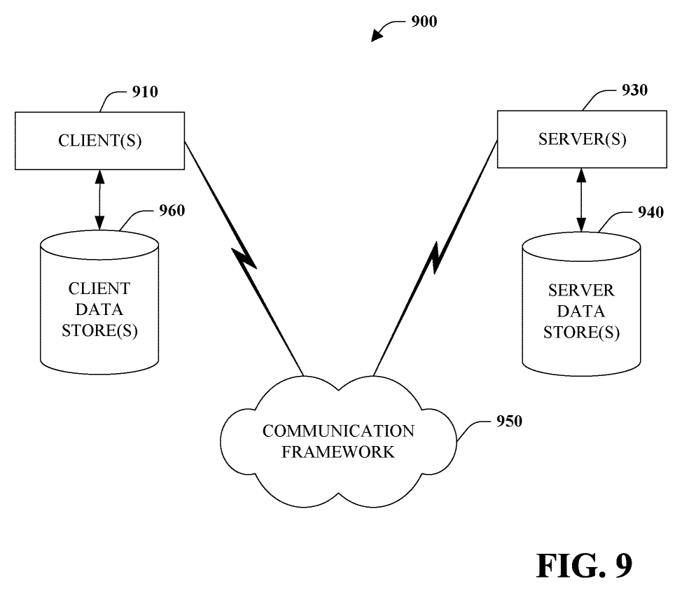

In order to provide a context for the various aspects of the disclosed subject matter, FIGS. 8 and 9 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 8, an exemplary environment 800 for implementing various aspects disclosed herein includes a computer 812 (e.g., desktop, laptop, server, hand held, programmable consumer or industrial electronics . . . ). The computer 812 includes a processing unit 814, a system memory 816 and a system bus 818. The system bus 818 couples system components including, but not limited to, the system memory 816 to the processing unit 814. The processing unit 814 can be any of various available microprocessors. It is to be appreciated that dual microprocessors, multi-core and other multiprocessor architectures, such as a CPU and/or GPU, can be employed as the processing unit 814.

The system memory 816 includes volatile and nonvolatile memory. The basic input/output system (BIOS), containing the basic routines to transfer information between elements within the computer 812, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 812 also includes removable/non-removable, volatile/non-volatile computer storage media. FIG. 8 illustrates, for example, mass storage 824. Mass storage 824 includes, but is not limited to, devices like a magnetic or optical disk drive, floppy disk drive, flash memory or memory stick. In addition, mass storage 824 can include storage media separately or in combination with other storage media.

FIG. 8 provides software application(s) 828 that act as an intermediary between users and/or other computers and the basic computer resources described in suitable operating environment 800. Such software application(s) 828 include one or both of system and application software. System software can include an operating system, which can be stored on mass storage 824, that acts to control and allocate resources of the computer system 812. Application software takes advantage of the management of resources by system software through program modules and data stored on either or both of system memory 816 and mass storage 824.

The computer 812 also includes one or more interface components 826 that are communicatively coupled to the bus 818 and facilitate interaction with the computer 812. By way of example, the interface component 826 can be a port (e.g., serial, parallel, PCMCIA, USB, FireWire . . . ) or an interface card (e.g., sound, video, network . . . ) or the like. The interface component 826 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 812 to output device(s) via interface component 826. Output devices can include displays (e.g., CRT, LCD, plasma . . . ), speakers, printers and other computers, among other things. Moreover, the interface component 826 can have an independent processor, such as a GPU on a graphics card, which can be utilized to perform functionalities described herein as shown supra.

FIG. 9 is a schematic block diagram of a sample-computing environment 900 with which the subject innovation can interact. The system 900 includes one or more client(s) 910. The client(s) 910 can be hardware and/or software (e.g., threads, processes, computing devices). The system 900 also includes one or more server(s) 930. Thus, system 900 can correspond to a two-tier client server model or a multi-tier model (e.g., client, middle tier server, data server), amongst other models. The server(s) 930 can also be hardware and/or software (e.g., threads, processes, computing devices). The servers 930 can house threads to perform transformations by employing the aspects of the subject innovation, for example. One possible communication between a client 910 and a server 930 may be in the form of a data packet transmitted between two or more computer processes.

The system 900 includes a communication framework 950 that can be employed to facilitate communications between the client(s) 910 and the server(s) 930. Here, the client(s) 910 can correspond to program application components and the server(s) 930 can provide the functionality of the interface and optionally the storage system, as previously described. The client(s) 910 are operatively connected to one or more client data store(s) 960 that can be employed to store information local to the client(s) 910. Similarly, the server(s) 930 are operatively connected to one or more server data store(s) 940 that can be employed to store information local to the servers 930.

By way of example, one or more clients 910 can request media content, which can be a video for example, from the one or more servers 930 via communication framework 950. The servers 930 can encode the video using the functionalities described herein, such as block parallel fast motion estimation, encode blocks of the video as related to a reference frame, and store the encoded content in server data store(s) 940. Subsequently, the server(s) 930 can transmit the data to the client(s) 910 utilizing the communication framework 950, for example. The client(s) 910 can decode the data according to one or more formats, such as H.264/AVC or other MPEG level decoding, utilizing the encoded motion vector or residue information to decode frames of the media. Alternatively or additionally, the client(s) 910 can store a portion of the received content within client data store(s) 960.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as comprising is interpreted when employed as a transitional word in a claim.

What is claimed is:

1. A system for providing block parallel motion estimation in video coding, comprising:
a block ordering component that specifies an order for encoding a plurality of blocks of a video frame according to a reference frame, at least a portion of the plurality of blocks are ordered for concurrent encoding; and
a motion estimation component that concurrently determines motion vectors related to the reference frame for the portion of the plurality of blocks.

2. The system of claim 1, the motion estimation component comprises a step search component that performs multiple step searches over a plurality of blocks of the reference frame to determine the motion vectors.

3. The system of claim 2, the step search component utilizes a three step search (TSS), a five step search (FSS), or a six step search (SSS) to determine the motion vectors.

4. The system of claim 1, further comprising a video coding component that computes a predicted motion vector for at least one of the portion of the plurality of block based at least in part on one or more adjacent encoded blocks

5. The system of claim 4, the video coding component encodes the at least one block based at least in part on a cost related to encoding a residue between the predicted motion vector and at least one of the determined motion vectors.

6. The system of claim 5, the block is encoded as the at least one determined motion vector.

7. The system of claim 1, the motion estimation component leverages a graphics processing unit (GPU) to concurrently determine the motion vectors.

8. The system of claim 1, the plurality of blocks are n by m pixels where n and m are positive integers.

9. A method for concurrently estimating motion in video block encoding, comprising:
separating a video frame into a plurality of blocks;
ordering the plurality of blocks for parallel encoding of a subset of the blocks where the encoding depends on one or more adjacent encoded blocks; and
concurrently encoding the subset of blocks according to the one or more adjacent blocks.

10. The method of claim 9, further comprising step searching a plurality of blocks of a reference video frame to determine at least one motion vector for encoding at least one block in the subset of blocks.

11. The method of claim 10, the step searching is performed according to a three step search (TSS), five step search (FSS), or six step search (SSS) algorithm.

12. The method of claim 10, further comprising predicting a motion vector for the at least one block based at least in part on the one or more adjacent encoded blocks.

13. The method of claim 12, the at least one block is encoded based at least in part on a cost associated with encoding a residue between the predicted motion vector and the determined motion vector.

14. The method of claim 13, the at least one block is encoded as a motion vector related to the residue.

15. The method of claim 13, the at least one block is encoded as the determined motion vector.

16. The method of claim 9, a graphics processing unit (GPU) is utilized with general programming computation (GPGPU) to perform the concurrent encoding.

17. The method of claim 9, the blocks are n by m pixels where n and m are equal or disparate positive integers.

18. A system for concurrently estimating motion in blocks of a video frame for encoding thereof, comprising:
means for ordering a plurality of blocks of a video frame according to a reference frame for concurrent encoding of at least a subset of the plurality of blocks; and
means for concurrently encoding the subset of the plurality of blocks as information regarding motion vectors related to the reference frame.

19. The system of claim 18, further comprising means for performing a multiple step search over the reference frame related to at least one block of the subset to determine the information regarding motion vectors.

20. The system of claim 18, further comprising means for computing a predicted motion vector for at least one block of the subset based at least in part on one or more adjacent encoded blocks.
